(19) United States
(12) Patent Application Publication
(10) Pub. No.: US 2025/0362515 A1
(43) Pub. Date: Nov. 27, 2025

(54) DISPLAY DEVICE AND OPTICAL SYSTEM

(71) Applicant: Panasonic Intellectual Property Management Co., Ltd., Osaka (JP)

(72) Inventors: Tsuneo UCHIDA, Chiba (JP); Satoshi KUZUHARA, Osaka (JP); Shunsuke TOMOMATSU, Osaka (JP)

(21) Appl. No.: 19/294,767

(22) Filed: Aug. 8, 2025

Related U.S. Application Data
(63) Continuation of application No. PCT/JP2024/003284, filed on Feb. 1, 2024.

(30) Foreign Application Priority Data
Feb. 10, 2023 (JP) 2023-019000

(51) Int. Cl. G02B 27/01; G02B 27/28

(52) U.S. Cl. CPC G02B 27/0172; G02B 27/283; G02B 2027/0134; G02B 2027/0178

(57) ABSTRACT

A display device includes: a first projection optical system including a first display; a second projection optical system including a second display; and an illumination optical system that guides light to the first and second projection optical systems. The illumination optical system includes a light source that collimates light source light including first and second polarized light and emits the collimated light, and a polarization beam splitter including a split surface where the light source light is split into first light in a first polarization state and second light in a second polarization state. The illumination optical system guides the first light to the first display and guides the second light to the second display. The first projection optical system projects the image displayed on the first display with the first light, and the second projection optical system projects the image displayed on the second display with the second light.

### CROSS REFERENCE TO RELATED APPLICATION

This application claims benefit of priority to International Application No. PCT/JP2024/003284, with an international filing date of Feb. 1, 2024, which claims priority of Japanese Patent Application No. 2023-019000 filed on Feb. 10, 2023, the entire content of which is incorporated herein by reference.

### BACKGROUND ART

### Technical Field

The present disclosure relates to a display device and an optical system.

### Background Art

For example, JP 2000-221499 A discloses a light source used for an image display device. The image display device includes a light modulation unit that reflects emitted light and performs light modulation in accordance with an image signal, and a projection unit that projects reflected light from the light modulation unit.

The light source described in JP 2000-221499 A includes a light emission unit and a polarization conversion unit. The light emission unit emits light with which the light modulation unit is irradiated. The polarization conversion unit is provided on a position just posterior to the light emission unit, and converts a polarization direction of the light so that at least more than 50% of the light emitted from the light emission unit is polarized in a predetermined direction and is emitted.

### SUMMARY

However, in JP 2000-221499 A, there is still room for improvement in terms of downsizing while improving utilization efficiency of light from a light source.

The present disclosure provides a display device and an optical system whose downsizing is achieved while the use efficiency of light from the light source is being improved.

A display device of the present disclosure includes a first projection optical system including a first display that displays an image, a second projection optical system including a second display that displays an image, and an illumination optical system that guides light to the first projection optical system and the second projection optical system. The illumination optical system includes a light source that collimates light source light including first polarized light and second polarized light and emits the collimated light, and a polarization beam splitter including a split surface where the light source light is split into first light in a first polarization state and second light in a second polarization state. The illumination optical system guides the first light to the first display and guides the second light to the second display. The first projection optical system projects the image displayed on the first display with the first light, and the second projection optical system projects the image displayed on the second display with the second light.

Further, an optical system of the present disclosure that guides light to a first display of a first projection optical system and a second display of a second projection optical system includes a light source that collimates light source light including first polarized light and second polarized light and emits the collimated light, and a polarization beam splitter including a split surface where the light source light is split into first light in a first polarization state and second light in a second polarization state. The first light is guided to the first display, and the second light is guided to the second display.

The present disclosure can provide a display device and an optical system whose downsizing is achieved while the use efficiency of light from the light source is being improved.

### BRIEF DESCRIPTION OF DRAWINGS

FIG. 1 is a schematic view for explaining an optical system in a first embodiment;

FIG. 2A is a schematic view for explaining a head mount display including the optical system of the first embodiment;

FIG. 2B is a schematic view for explaining the head mount display including the optical system of the first embodiment;

FIG. 3 is a schematic view for explaining an optical system in a second embodiment;

FIG. 4 is a schematic view for explaining an optical system in a third embodiment;

FIG. 5 is a schematic view for explaining an optical system in a fourth embodiment;

FIG. 6 is a schematic view for explaining an optical system in a fifth embodiment;

FIG. 7 is a schematic view for explaining another example of a positional relationship between a retardation plate and a reflector element;

FIG. 8 is a schematic view for explaining another example of a positional relationship between the retardation plate and the reflector element;

FIG. 9 is a schematic view for explaining another example of a positional relationship between the retardation plate and the reflector element;

FIG. 10 is a schematic view for explaining another example of the reflector element;

FIG. 11 is a schematic view for explaining another example of the reflector element;

FIG. 12 is a schematic view for explaining another example of the reflector element;

FIG. 13 is a schematic view for explaining another example of the reflector element;

FIG. 14 is a schematic view for explaining another example of the optical system;

FIG. 15 is a schematic view for explaining another example of the optical system;

FIG. 16 is a schematic view for explaining a display device in a sixth embodiment;

FIG. 17A is a schematic view for explaining one example of a display device in a seventh embodiment;

FIG. 17B is a schematic view for explaining another example of the display device in the seventh embodiment;

FIG. 17C is a schematic view for explaining another example of the display device in the seventh embodiment;

FIG. 18A is a schematic view for explaining one example of a display device in an eighth embodiment;

FIG. 18B is a schematic view for explaining another example of the display device in the eighth embodiment;

FIG. 18C is a schematic view for explaining another example of the display device in the eighth embodiment;

FIG. 18D is a schematic view for explaining another example of the display device in the eighth embodiment;

FIG. 19 is a schematic view for explaining a display device in a ninth embodiment;

FIG. 20A is a schematic view for explaining one example of a display device in a tenth embodiment; and

FIG. 20B is a schematic view for explaining another example of the display device in the tenth embodiment.

### DETAILED DESCRIPTION

### First Embodiment

A first embodiment will be described below with reference to the drawings. In the first embodiment, an optical system applied to a head mount display will be described as an example of a projection type image display device.

### [1-1. Configuration of Optical System]

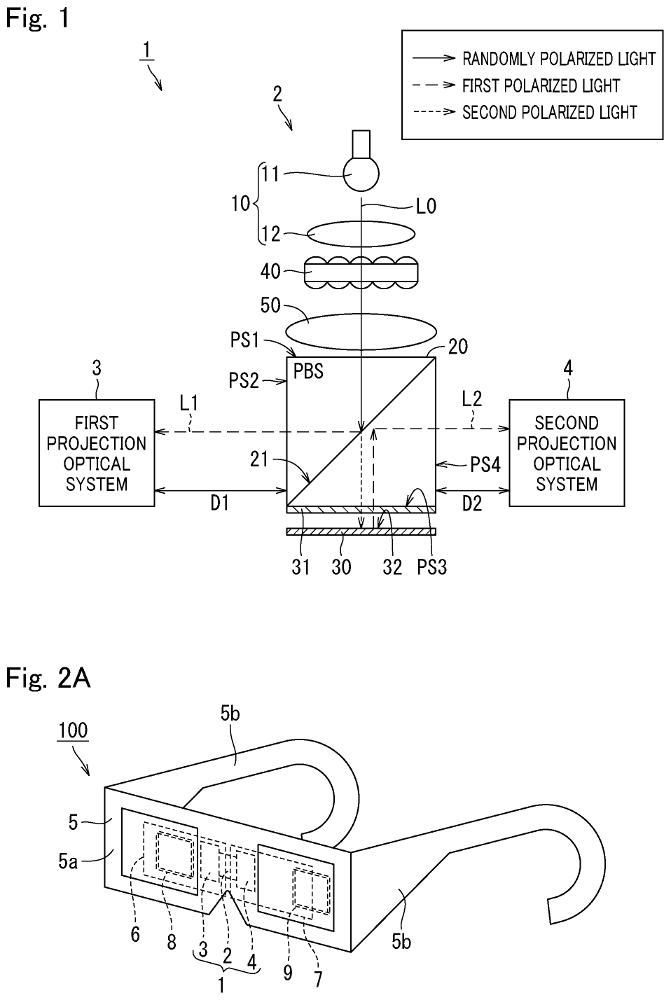

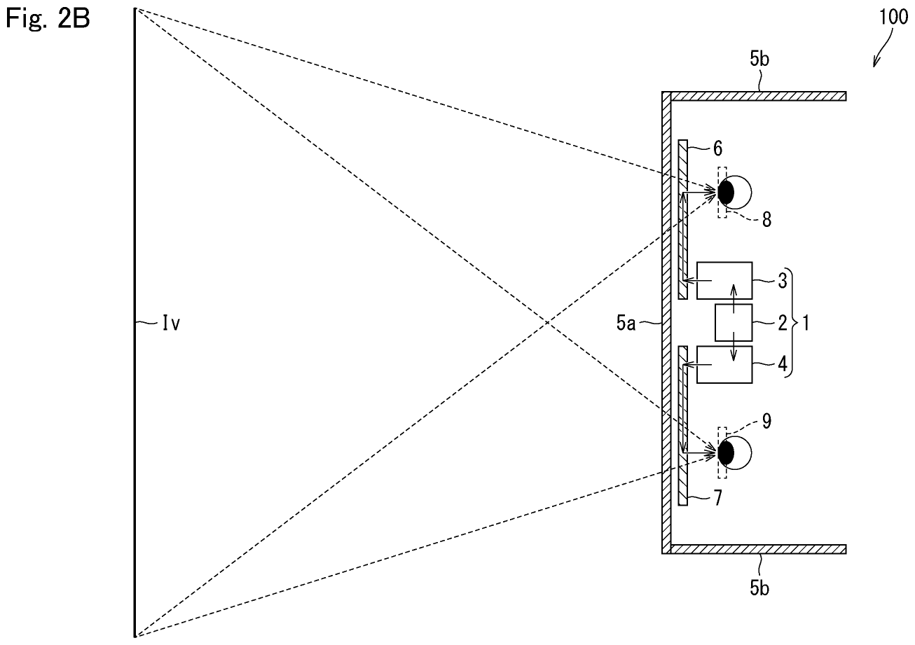

FIGS. 1, 2A, and 2B are referred to. FIG. 1 is a schematic view for explaining an optical system 1 in the first embodiment;

As illustrated in FIG. 1, the optical system 1 includes an illumination optical system 2, a first projection optical system 3, and a second projection optical system 4. In the illumination optical system 2, light from a light source 10 is split into a plurality of lights by a polarization beam splitter (PBS) 20, polarization states of the plurality of split lights are aligned, and the plurality of lights is output in two different directions. The first and second projection optical systems 3 and 4 receive the light output from the illumination optical system 2 and project an image on a display screen.

In the present embodiment, in the illumination optical system 2, randomly polarized light L0 from the light source 10 is split into first light L1 and second light L2 by the polarization beam splitter 20. The polarization states of the first light L1 and the second light L2 are made the same. In addition, the illumination optical system 2 outputs the first light L1 to the first direction and outputs the second light L2 to the second direction different from the first direction. The first direction and the second direction are directions intersecting with the direction where the randomly polarized light L0 is output. Specifically, the first direction is a right direction, and the second direction is a left direction. The first projection optical system 3 is located in the first direction, and receives the first light L1 to project an image. The second projection optical system 4 is located in the second direction, and receives the second light L2 to project an image.

FIGS. 2A and 2B are schematic views for explaining a head mount display 100 including the optical system 1 of the first embodiment. FIG. 2A is a perspective view of one example of the head mount display 100. FIG. 2B illustrates one example of an internal configuration of the head mount display 100 from a planar view. As illustrated in FIGS. 2A and 2B, the optical system 1 is applied to the head mount display 100. The head mount display 100 includes the optical system 1, a casing frame 5, a first light guide device 6, and a second light guide device 7. The head mount display 100 further includes a first display screen viewing region 8 and a second display screen viewing region 9. The first display screen viewing region 8 and the second display screen viewing region 9 are provided respectively in regions where the eyes of a user are located. For example, the first light guide device 6 and the second light guide device 7 guide the image light from the first projection optical system 3 and the second projection optical system 4 to the first display screen viewing region 8 and the second display screen viewing region 9, that is, guide the image light to the eyes of the user. Further, the first light guide device 6 and the second light guide device 7 may include, for example, a light guide plate having a diffractive structure in a transmissive optical material as a configuration of superimposing an image on the outside world. In a case where the first light guide device 6 and the second light guide device 7 are constituted respectively by the light guide plates having diffraction grating, the first light guide device 6 and the second light guide device 7 can efficiently guide the light in a specific polarization state guided from the first projection optical system 3 and the second projection optical system 4 as the image light to the eyes of the user.

The casing frame 5 is a spectacle-shaped frame. For example, the casing frame 5 includes a front frame 5a and a support frame 5b extending from both sides of the front frame 5a. In a state where a user wears the head mount display 100, the front frame 5a is placed in front of the eyes of the user, and the support frame 5b is supported by ears of the user.

The optical system 1 is housed inside the center of the front frame 5a. On the front frame 5a, the first light guide device 6 and the second light guide device 7 are disposed with the optical system 1 being interposed therebetween. In a state where the user wears the head mount display 100, the first display screen viewing region 8 and the second display screen viewing region 9 are placed in front of the eyes of the user.

Image light projected from the first projection optical system 3 is projected on the first light guide device 6. Image light projected from the second projection optical system 4 is projected on the second light guide device 7.

When the image light is projected from the first light guide device 6 on the first display screen viewing region 8 and the eyes of the user are within the first display screen viewing region 8, the user can completely view the display screen. When the image light is projected from the second light guide device 7 on the second display screen viewing region 9 and the user's eyes are within the second display screen viewing region 9, the user can completely view the display screen.

As described above, the head mount display 100 includes the first projection optical system 3 and the second projection optical system 4 with which the optical system 1 projects light. The first projection optical system 3 projects the image for the right eye of the user. The second projection optical system 4 projects the image for the left eye of the user. Further, the head mount display 100 includes the first light guide device 6 and the second light guide device 7. The first light guide device 6 guides the image light projected by the first projection optical system 3 to the eyes of the user. The second light guide device 7 guides the image light projected by the second projection optical system 4 to the eye of the user.

The head mount display 100 may include a so-called pupil dilation type light guide body. The light guide body can duplicate a plurality of light fluxes of image light from one light flux of incident image light. The light guide body may duplicate the light fluxes in a first light flux direction and a second light flux direction to dilate the display image visual recognition regions 8 and 9. The user can visually recognize each of the plurality of light fluxes of image light as a virtual image Iv, and can widen the display image visual recognition regions 8 and 9 where the user can visually recognize the image light.

For example, the pupil dilation type light guide body may include a coupling region, a first dilation region, and a second dilation region. In the coupling region, the image light from the first light guide device 6 and the second light guide device 7 are received, and a traveling direction is changed. The first dilation region is dilated in the first light flux direction. The second dilation region is dilated in the second light flux direction. The first light flux direction and the second light flux direction may cross each other, for example, may be orthogonal to each other.

Each of the coupling region, the first dilation region, and the second dilation region has diffraction power for diffracting the image light. A diffractive structural element such as an embossed hologram or a volume hologram may be formed in each of the regions. The embossed hologram is, for example, a diffraction grating. The volume hologram is, for example, a periodic refractive index distribution in a dielectric film.

For example, in the coupling region, the traveling direction of the image light having entered from the outside may be changed to be directed to the first dilation region by the diffraction power. In the first dilation region where the diffractive structural element is disposed, the image light may be duplicated by dividing the incident image light into the image light traveling in the first light flux direction and the image light traveling to the second dilation region using the diffraction power. In the second dilation region where the diffractive structural element is disposed, the image light may be duplicated by dividing the incident image light into the image light traveling in the second light flux direction and the image light emitted from the second dilation region using the diffraction power.

Note that the head mount display 100 is not limited to an eyeglass type display. For example, the head mount display 100 may be configured to be attached to a head without the support frame.

Details of the illumination optical system 2 will be described below.

Returning to FIG. 1, the illumination optical system 2 includes the light source 10, the polarization beam splitter 20, a reflector element 30, a retardation plate 31, a lens array element 40, and a lens element 50.

The light source 10 collimates and emits the randomly polarized light L0. For example, the light source 10 changes randomly polarized light having a red (R) light component, a green (G) light component, and a blue (B) light component into approximately parallel light and emits the approximately parallel light.

The light source 10 includes a light source element 11 and a collimator element 12.

The light source element 11 generates the randomly polarized light L0. The light source element 11 is a light emitting diode (LED) or the like, and a plurality of optical elements can be also collectively described as the light source element 11.

At the collimator element 12, the randomly polarized light L0 generated by the light source element 11 is collimated. At the collimator element 12, the randomly polarized light L0 is changed to approximately parallel light. For example, the collimator element 12 is a collimator lens.

Note that the collimator element 12 may include a plurality of lenses. The collimator element 12 is not limited to the collimator lens. The collimator element 12 may be an optical element that enables the randomly polarized light L0 to be collimated. For example, the collimator element 12 may be an optical element such as a mirror, or a diffractive optical element.

The randomly polarized light L0 emitted from the light source 10 passes through the lens array element 40 and the lens element 50 to enter the polarization beam splitter 20.

The lens array element 40 is an optical element in which a plurality of lens elements is arranged on a substrate. The lens array element 40 is disposed between the light source 10 and the polarization beam splitter 20. At the lens array element 40, the randomly polarized light L0 emitted from the light source 10 is split into a plurality of secondary light source lights.

The lens element 50 is a lens that condenses the plurality of secondary light source lights. The lens element 50 is, for example, a relay lens. At the lens element 50, the plurality of secondary light source lights split by the lens array element 40 is condensed.

The polarization beam splitter 20 splits the randomly polarized light L0 into the first light L1 and the second light L2, guides the first light L1 to the first direction, and guides the second light L2 to the second direction. The polarization beam splitter 20 includes a split surface 21 for splitting the randomly polarized light L0 into the first light L1 and the second light L2.

At the split surface 21, the first polarized light is reflected and the second polarized light is transmitted. At the split surface 21, the randomly polarized light L0 is split into the first light L1 in the first polarization state and the second light L2 in the second polarization state. The first light L1 is obtained by reflecting the first polarized light. The second light L2 is obtained by transmitting the second polarized light. The split surface 21 is provided inside the polarization beam splitter 20.

In the present embodiment, the first polarized light is S-polarized light, and the second polarized light is P-polarized light. The first polarization state is a state obtained by the S-polarized light, and the second polarization state is a state obtained by P-polarized light. The first polarized light and the second polarized light are linearly polarized light.

The polarization beam splitter 20 has a cube shape. For example, the polarization beam splitter 20 includes first to fourth surfaces PS1 to PS4 in a cross section including the light source 10, the first projection optical system 3, and the second projection optical system 4. The first surface PS1 faces the third surface PS3, and the second surface PS2 faces the fourth surface PS4. Further, the first surface PS1 and the third surface PS3 are orthogonal to the second surface PS2 and the fourth surface PS4.

The light source 10, the lens array element 40, and the lens element 50 are disposed on a first surface PS1 side of the polarization beam splitter 20. The first projection optical system 3 is disposed on a second surface PS2 side. The reflector element 30 and the retardation plate 31 are disposed on a third surface PS3 side. The second projection optical system 4 is disposed on a fourth surface PS4 side.

The first surface PS1 of the polarization beam splitter 20 is an incident surface where the randomly polarized light L0 from the light source 10 enters. The second surface PS2 is an outgoing surface from which the first light L1 is emitted. The third surface PS3 is a surface where the second light L2 is emitted and enters. The fourth surface PS4 is an outgoing surface where the second light L2 is emitted.

The reflector element 30 is an optical element where light is reflected. The reflector element 30 includes a reflecting surface 32 where light is reflected. The reflector element 30 is disposed on an optical path of the second light L2 transmitted through the split surface 21 on the third surface PS3 side of the polarization beam splitter 20. Further, the reflector element 30 is disposed away from the third surface PS3 of the polarization beam splitter 20 and is disposed close to the retardation plate 31. For example, the reflector element 30 is disposed within a range between 0.05 mm and 2.0 mm, inclusive, from retardation plate 31.

From the reflecting surface 32, the second light L2 split from the split surface 21 is reflected. Specifically, at the reflecting surface 32, the second light L2 is reflected, and is guided to the split surface 21 again.

The reflecting surface 32 is provided on the side of the reflector element 30 facing the third surface PS3 of the polarization beam splitter 20.

For example, as the reflector element 30, a mirror or a lens having a curved surface can be used.

With the retardation plate 31, the polarization state of polarized light is changed. The retardation plate 31 is an optical element for changing the polarization state by giving predetermined retardation to polarized light. The retardation plate 31 is disposed between the polarization beam splitter 20 and the reflector element 30.

The retardation plate 31 is disposed close to the polarization beam splitter 20. Specifically, the retardation plate 31 is disposed on the third surface PS3 of the polarization beam splitter 20.

The retardation plate 31 is a ¼ wave plate. The retardation plate 31 gives retardation of λ/4 to an electric field vibration direction of the polarized light.

At the retardation plate 31, the second polarization state of the second light L2 is changed to the first polarization state. The second light L2 passes through the retardation plate 31 to enter the reflecting surface 32 from the split surface 21, and is reflected from the reflecting surface 32. The second light L2 reflected from the reflecting surface 32 passes through the retardation plate 31 to enter the split surface 21. In such a way, the second light L2 passes through the retardation plate 31 twice to have retardation of λ/2. As a result, the second polarization state of the second light L2 is changed to the first polarization state.

The retardation plate 31 is not limited to the ¼ wave plate. The retardation plate 31 may be any plate for giving retardation in order to change the second polarization state of the second light L2 to the first polarization state. For example, the retardation plate 31 may be configured by two ⅛ wave plates, or by four 1/16 wave plates. Further, the retardation plate 31 may give retardation of 0.24×λ to 0.26×λ to the electric field vibration direction of the polarized light.

The first projection optical system 3 is disposed on the second surface PS2 side of the polarization beam splitter 20. The first projection optical system 3 is disposed on a position away from the second surface PS2 of the polarization beam splitter 20 by a first distance D1. The first distance D1 is a distance between the polarization beam splitter 20 and the first projection optical system 3. Specifically, the first distance D1 is a distance from the second surface PS2 of the polarization beam splitter 20 to an optical element disposed at a position closest to the second surface PS2 among the optical elements constituting the first projection optical system 3.

The second projection optical system 4 is disposed on the fourth surface PS4 side of the polarization beam splitter 20. From the fourth surface side PS4, the second light L2 is emitted. The second projection optical system 4 is disposed on a position away from the fourth surface PS4 of the polarization beam splitter 20 by a second distance D2. The second distance D2 is a distance between the polarization beam splitter 20 and the second projection optical system 4. Specifically, the second distance D2 is a distance from the fourth surface PS4 of the polarization beam splitter 20 to an optical element disposed at a position closest to the fourth surface PS4 among the optical elements constituting the second projection optical system 4.

The first distance D1 and the second distance D2 are set so that the first light L1 entering the first projection optical system 3 and the second light L2 entering the second projection optical system 4 have approximately the same luminance distribution. Specifically, the first distance D1 and the second distance D2 are set so that the length of an optical path until the light emitted from the lens element 50 enters the first projection optical system 3 is approximately identical to the length of an optical path until the light emitted from the lens element 50 enters the second projection optical system 4.

In the polarization beam splitter 20, the first light L1 is reflected from the split surface 21 and then emitted from the second surface PS2. On the other hand, the second light L2 is transmitted through the split surface 21, and then reflected from the reflecting surface 32. The second light L2 is further reflected from the split surface 21, and then emitted from the fourth surface PS4. In such a way, in the polarization beam splitter 20, the optical path of the second light L2 is longer than the optical path of the first light L1. Therefore, by setting the second distance D2 to be shorter than the first distance D1, the first light L1 entering the first projection optical system 3 and the second light L2 entering the second projection optical system 4 may have approximately the same luminance distribution.

### [1-2. Operation of Optical System]

Next, the operation of the optical system 1 will be described.

The randomly polarized light L0 that has been collimated is emitted from the light source 10. At the lens array element 40, the randomly polarized light L0 is split into a plurality of secondary light source lights. The plurality of secondary light source lights is condensed at the lens element 50 and enters the first surface PS1 of the polarization beam splitter 20.

In the polarization beam splitter 20, the randomly polarized light L0 enters the split surface 21, and is split into the first light L1 in the first polarization state and the second light L2 in the second polarization state at the split surface 21. The first polarized light out of the randomly polarized light L0 is reflected from the split surface 21, and the second polarized light is transmitted therethrough. The first polarized light out of the randomly polarized light L0 is reflected from the split surface 21 to obtain the first light L1 in the first polarization state. The second polarized light out of the randomly polarized light L0 is transmitted through the split surface 21 to obtain the second light L2 in the second polarization state.

At the split surface 21, the first light L1 is guided to the first direction intersecting the incident direction of the randomly polarized light L0. The first light L1 is guided from the split surface 21 toward the second surface PS2 and emitted from the second surface PS2. The first light L1 emitted from the second surface PS2 enters the first projection optical system 3. The first projection optical system 3 receives the first light L1 to project an image.

The second light L2 passes from the split surface 21 through the retardation plate 31 disposed on the third surface PS3 to enter the reflecting surface 32 of the reflector element 30. At this time, the second light L2 passes through the retardation plate 31 to have retardation of λ/4. The second light L2 is reflected from the reflecting surface 32 and passes through the retardation plate 31 to enter again the split surface 21. At this time, the second light L2 passes through the retardation plate 31 to further have retardation of λ/4.

In such a way, the second light L2 passes through the retardation plate 31 twice to have retardation of λ/2. As a result, the second polarization state of the second light L2 is changed to the first polarization state.

The second light L2 in the first polarization state is reflected from the split surface 21 and guided in a second direction opposite to the first direction. The second light L2 is guided from the split surface 21 toward the fourth surface PS4 and emitted from the fourth surface PS4. The second light L2 emitted from the fourth surface PS4 enters the second projection optical system 4. The second projection optical system 4 receives the second light L2 to project an image.

### [2. Effects, Etc.]

As described above, the optical system 1 includes the light source 10, the polarization beam splitter 20, the reflector element 30, and the retardation plate 31. The light source 10 collimates and emits the randomly polarized light L0. The polarization beam splitter 20 includes the split surface 21 where the randomly polarized light L0 is split into the first light L1 in the first polarization state and the second light L2 in the second polarization state. The first light L1 is obtained by reflecting the first polarized light out of the randomly polarized light L0. The second light L2 is obtained by transmitting the second polarized light out of the randomly polarized light L0. The reflector element 30 includes the reflecting surface 32 from which the second light L2 split from the split surface 21 is reflected. The retardation plate 31 is disposed between the polarization beam splitter 20 and the reflector element 30. At the split surface 21, the first light L1 is guided in the first direction. At the retardation plate 31, the second polarization state of the second light L2 is changed to the first polarization state. At the split surface 21, the second light L2 changed to the first polarization state is reflected, and guided in the second direction different from the first direction.

With such a configuration, downsizing can be achieved while the light use efficiency of the light source 10 is being improved. Specifically, the optical system 1 splits the randomly polarized light L0 from the light source 10 into the first light L1 in the first polarization state and the second light L2 in the second polarization state at the split surface 21 of the polarization beam splitter 20. The first light L1 is guided by the split surface 21, and the second polarization state of the second light L2 output in the first direction is changed to the first polarization state by using the reflector element 30 and the retardation plate 31. The second light L2 in the first polarization state is guided by the split surface 21 and output in the second direction.

In general, two light sources are used in the optical system that outputs two lights whose polarization states are aligned. Therefore, the downsizing of the optical system may be difficult. The optical system 1 according to the present embodiment splits the randomly polarized light L0 from one light source 10 into the first light L1 and the second light L2, and outputs the first light L1 and the second light L2 with their polarization states being aligned. Since the light source 10 can be shared for outputting the first light L1 and outputting the second light L2, the downsizing of the optical system 1 can be achieved while the light use efficiency of the light source 10 is being improved. Further, the manufacturing cost of the optical system 1 can be reduced.

In the optical system 1, the polarization state of the second light L2 is changed to be the same as that of the first light L1 using the reflector element 30 and the retardation plate 31. As a result, the light use efficiency of the light source 10 is improved. Note that, in general, in most of optical systems that split random light using the polarization beam splitter, light entering a projection optical system is extracted and other light is discarded. In the optical system 1 according to the present embodiment, the light use efficiency is improved by changing the polarization state and utilizing the second light L2 without discarding this light.

The retardation plate 31 is a ¼ wave plate. With such a configuration, since the polarization state of the second light L2 can be changed with a simpler configuration, the optical system 1 can be further downsized.

The first light L1 enters the first projection optical system 3, and the second light L2 enters the second projection optical system 4. With such a configuration, the first projection optical system 3 can receive the first light L1 and project an image, and the second projection optical system 4 can receive the second light L2 and project an image. Thus, the two images can be displayed on a display screen or the like.

The first projection optical system 3 is disposed away from the second surface PS2 of the polarization beam splitter 20 by the first distance D1. The second surface PS2 of the polarization beam splitter 20 is an outgoing surface of the first light L1. The second projection optical system 4 is disposed away from the fourth surface PS4 of the polarization beam splitter 20 by the second distance D2. The fourth surface PS4 of the polarization beam splitter 20 is an outgoing surface of the second light L2. The second distance D2 is shorter than the first distance D1.

With such a configuration, the first light L1 entering the first projection optical system 3 and the second light L2 entering the second projection optical system 4 have approximately the same luminance distribution. That is, the luminance distributions of the first light L1 and the second light L2 are made uniform.

The optical system 1 includes the lens array element 40 where light is split into a plurality of secondary light source lights, and the lens element 50 where the plurality of secondary light source lights from the lens array element 40 is condensed. With such a configuration, the luminance distributions of the first light L1 and the second light L2 respectively entering the first projection optical system 3 and the second projection optical system 4 can be made uniform.

The lens array element 40 is disposed between the light source 10 and the polarization beam splitter 20. With such a configuration, the optical system 1 can be downsized while the luminance distributions of the first light L1 and the second light L2 are made more uniform.

The lens element 50 is disposed between the lens array element 40 and the polarization beam splitter 20. With such a configuration, the optical system 1 can be downsized while the luminance distributions of the first light L1 and the second light L2 are made more uniform.

The retardation plate 31 is disposed close to the polarization beam splitter 20. With such a configuration, the optical system 1 can be downsized while deterioration of the retardation plate 31 is being suppressed.

The light source 10 includes the light source element 11 where the randomly polarized light L0 is generated and the collimator element 12 where the randomly polarized light L0 generated by the light source element 11 is collimated. With such a configuration, the optical system 1 can be downsized while the collimated light is being easily emitted.

The head mount display 100 includes the optical system 1 described above. Such a configuration can produce the effect similar to the effect of the optical system 1 described above.

### Second Embodiment

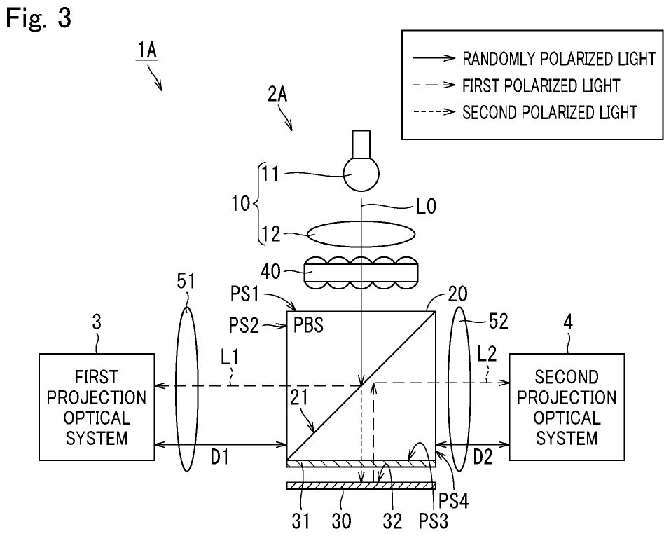

An optical system 1A according to a second embodiment will be described with reference to FIG. 3. FIG. 3 is a schematic view for explaining the optical system 1A according to the second embodiment;

In the optical system 1A according to the second embodiment, a first lens element 51 where first light L1 is condensed is disposed on an optical path of the first light L1 emitted from a polarization beam splitter 20. A second lens element 52 where second light L2 is condensed is disposed on an optical path of the second light L2 emitted from the polarization beam splitter 20. Note that the lens element is not disposed between a lens array element 40 and the polarization beam splitter 20. The points of the configuration other than the above-described points and points described below are common between the optical system 1A according to the second embodiment and the optical system 1 according to the first embodiment.

As illustrated in FIG. 3, an illumination optical system 2A of the optical system 1A includes the first lens element 51 and the second lens element 52.

The first lens element 51 is disposed on the optical path of the first light L1 emitted from the polarization beam splitter 20. The first lens array element 51 is disposed between the polarization beam splitter 20 and a first projection optical system 3. The first lens element 51 condenses the first light L1.

The second lens element 52 is disposed on the optical path of the second light L2 emitted from the polarization beam splitter 20. The second lens element 52 is disposed between the polarization beam splitter 20 and a second projection optical system 4. The second lens element 52 condenses the second light L2.

For example, the first lens element 51 and the second lens element 52 are relay lenses having equal refracting power.

Even in such a configuration, the first light L1 entering the first projection optical system 3 can be condensed by the first lens element 51, and the luminance distribution of the first light L1 can be made uniform. The second light L2 entering the second projection optical system 4 can be condensed at the second lens element 52, and the luminance distribution of the second light L2 can be made uniform.

Further, since first lens element 51 and second lens element 52 are the same lens, components can be shared.

### Third Embodiment

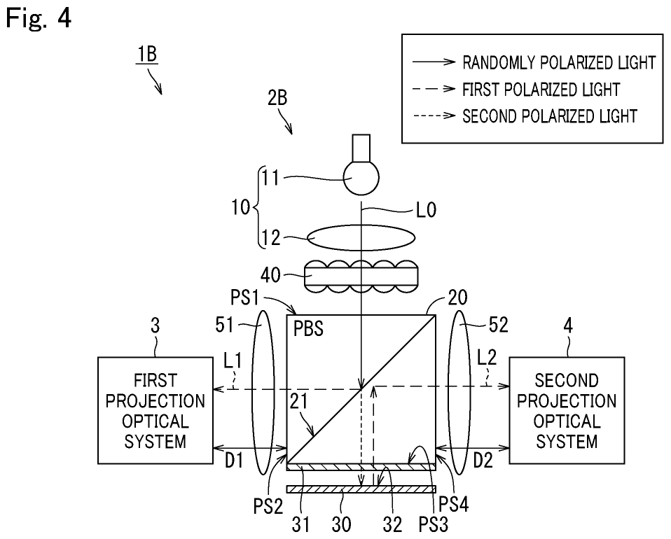

An optical system 1B according to a third embodiment will be described with reference to FIG. 4. FIG. 4 is a schematic view for explaining the optical system 1B according to the third embodiment.

In optical system 1B according to the third embodiment, the first lens element 51 and the second lens element 52 are different relay lenses. A first distance D1 is shortened. The points of the configuration other than the above-described points and points described below are common between the optical system 1B according to the third embodiment and the optical system 1A according to the second embodiment.

As illustrated in FIG. 4, an illumination optical system 2B of the optical system 1B includes a first lens element 51 and a second lens element 52. Different relay lenses are used for the first lens element 51 and the second lens element 52. For example, the refracting power of the first lens element 51 is greater than the refracting power of the second lens element 52.

With such a configuration, the first light L1 entering a first projection optical system 3 can be condensed at the first lens element 51, and the luminance distribution of the first light L1 can be made uniform. The second light L2 entering the second projection optical system 4 can be condensed at the second lens element 52, and the luminance distribution of the second light L2 can be made uniform.

Further, the first distance D1 can be shortened to be equivalent to a second distance D2 by increasing the refracting power of the first lens element 51 to be greater than the refracting power of the second lens element 52. As a result, the optical system 1A can be further downsized.

### Fourth Embodiment

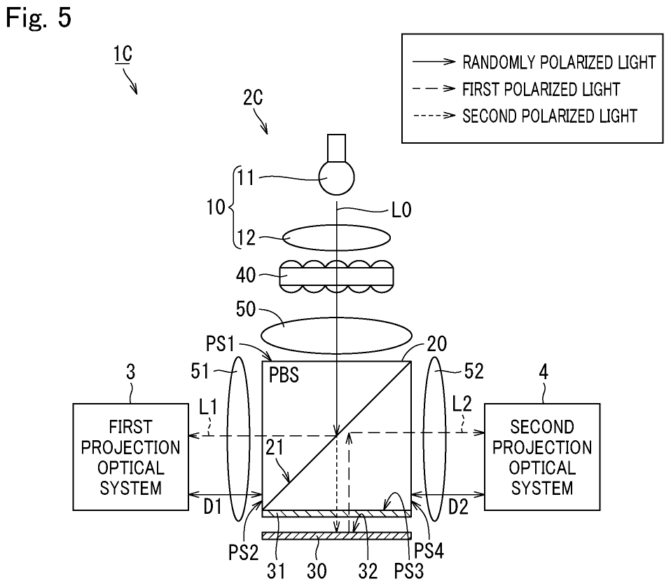

An optical system 1C according to a fourth embodiment will be described with reference to FIG. 5. FIG. 5 is a schematic view for explaining the optical system 1C according to the fourth embodiment.

In the optical system 1C according to the fourth embodiment, a first lens element 51 where first light L1 is condensed is disposed on an optical path of the first light L1 emitted from a polarization beam splitter 20. A second lens element 52 where second light L2 is condensed is disposed on an optical path of the second light L2 emitted from the polarization beam splitter 20. The points of the configuration other than the above-described points and points described below are common between the optical system 1C according to the fourth embodiment and the optical system 1 according to the first embodiment.

As illustrated in FIG. 5, an illumination optical system 2C of the optical system 1C includes the first lens element 51 and the second lens element 52.

The first lens element 51 is disposed on the optical path of the first light L1 emitted from the polarization beam splitter 20. The first lens array element 51 is disposed between the polarization beam splitter 20 and a first projection optical system 3. The first lens element 51 condenses the first light L1.

The second lens element 52 is disposed on the optical path of the second light L2 emitted from the polarization beam splitter 20. The second lens element 52 is disposed between the polarization beam splitter 20 and a second projection optical system 4. The second lens element 52 condenses the second light L2.

For example, the first lens element 51 and the second lens element 52 are relay lenses. Different relay lenses are used for the first lens element 51 and the second lens element 52. For example, the refracting power of the first lens element 51 is greater than the refracting power of the second lens element 52.

With such a configuration, the first light L1 entering the first projection optical system 3 can be condensed at the first lens element 51, and the luminance distribution of the first light L1 can be made uniform. Second light L2 entering the second projection optical system 4 can be condensed at the second lens element 52, and the luminance distribution of the second light L2 can be made uniform.

Further, the first distance D1 between the polarization beam splitter 20 and the first projection optical system 3 can be shortened to be equivalent to a second distance D2 by increasing the refracting power of the first lens element 51 to be greater than the refracting power of the second lens element 52. As a result, the optical system 1C can be further downsized.

### Fifth Embodiment

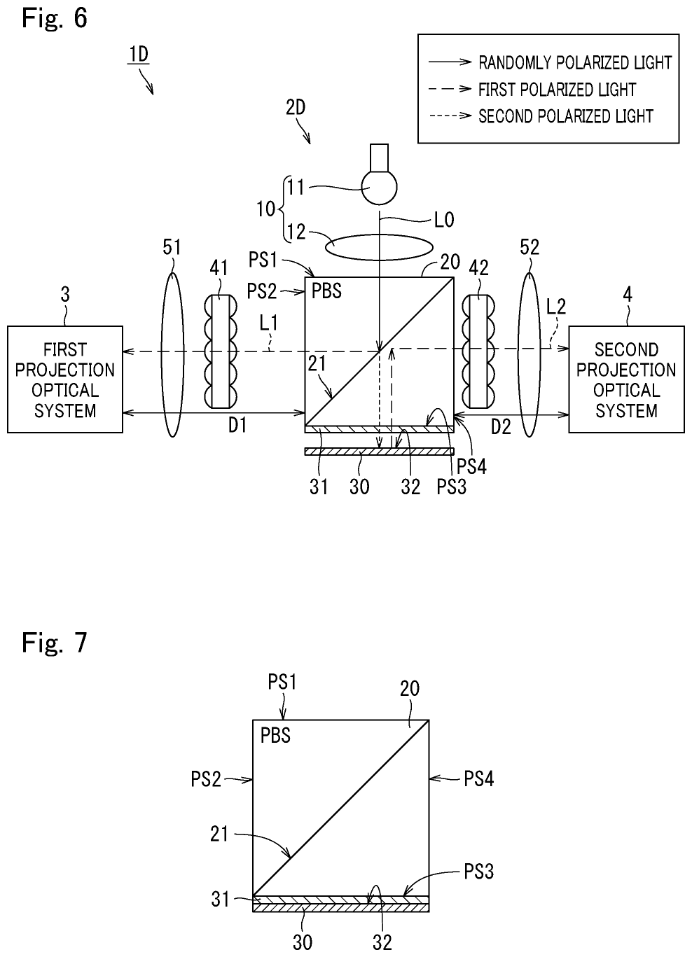

An optical system 1D according to a fifth embodiment will be described with reference to FIG. 6. FIG. 6 is a schematic view for explaining the optical system 1D according to the fifth embodiment.

In the optical system 1D according to the fifth embodiment, a first lens array element 41 is disposed between a polarization beam splitter 20 and a first lens element 51. A second lens array element 42 is disposed between the polarization beam splitter 20 and a second lens element 52. Note that no lens array element is disposed between a light source 10 and the polarization beam splitter 20. The points of the configuration other than the above-described points and points described below are common between the optical system 1D according to the fifth embodiment and the optical system 1A according to the second embodiment.

As illustrated in FIG. 6, an illumination optical system 2D of the optical system 1D includes the first lens array element 41 and the second lens array element 42.

The first lens array element 41 is disposed between the polarization beam splitter 20 and the first lens element 51. At the first lens array element 41, first light L1 emitted from the polarization beam splitter 20 is split into a plurality of secondary light source lights. The plurality of secondary light source lights is condensed at the first lens element 51 and enters a first projection optical system 3.

The second lens array element 42 is disposed between the polarization beam splitter 20 and the second lens element 52. At the second lens array element 42, second light L2 emitted from the polarization beam splitter 20 is split into a plurality of secondary light source lights. The plurality of secondary light source lights is condensed at the second lens element 52 and enters the second projection optical system 4.

With such a configuration, the luminance distribution of the first light L1 entering the first projection optical system 3 can be made uniform by the first lens array element 41 and the first lens element 51. Further, the distribution of the second light L2 entering the second projection optical system 4 can be made uniform by the second lens array element 42 and the second lens element 52.

### (Other Embodiments of Optical System)

Another embodiment of the optical system will be described below.

In the above embodiments, the example where the light source light emitted from the light source 10 is randomly polarized light has been described. However, the light source light may be another light source light. For example, the light source light may be linearly polarized light including components of first polarized light and second polarized light, light obtained by combining the first polarized light and the second polarized light, circularly polarized light, elliptically polarized light, or light obtained by combining such light. That is, the light source light may be light including the first polarized light and the second polarized light.

In the above-described embodiments, the example where the optical system 1 is applied to the head mount display 100 has been described. However, the optical system 1 may be applied to devices other than the head mount display 100. For example, the optical system 1 may be applied to a projection type image display device such as a projector that projects two images.

In the above-described embodiments, the example where the polarization beam splitter 20 has a cube shape has been described. However, the shape of the polarization beam splitter 20 is not limited to the cube shape. For example, the polarization beam splitter 20 may have a plate shape. In this case, the first distance D1 may be a distance from the center of the split surface 21 to the first projection optical system 3, and the second distance D2 may be a distance from the center of the split surface 21 to the second projection optical system 4.

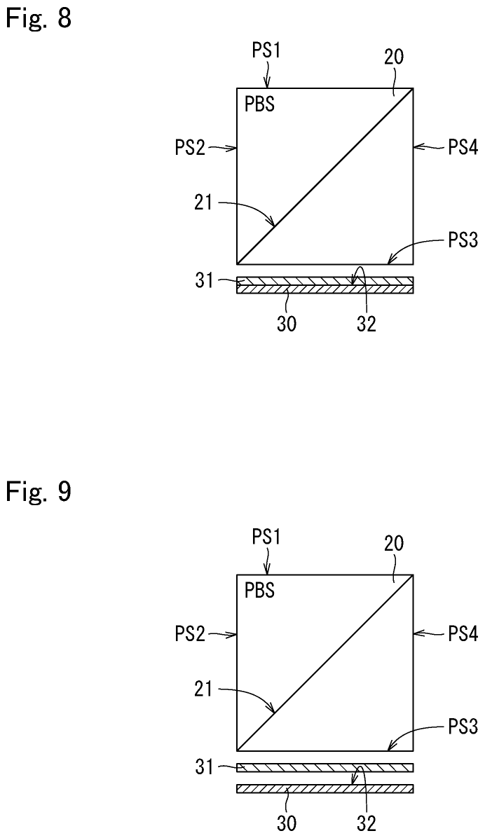

In the above-described embodiments, the example where the reflector element 30 is disposed close to the retardation plate 31 has been described. However, as illustrated in FIG. 7, the reflector element 30 may be disposed in close contact with retardation plate 31.

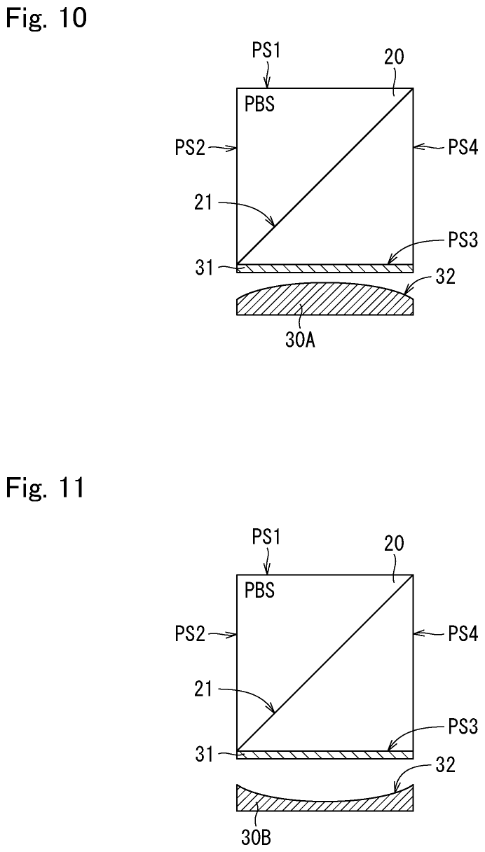

In the above-described embodiments, the example where the retardation plate 31 is disposed in close contact with the third surface PS3 of the polarization beam splitter 20 has been described. However, as illustrated in FIG. 8, the retardation plate 31 may be disposed away from the polarization beam splitter 20.

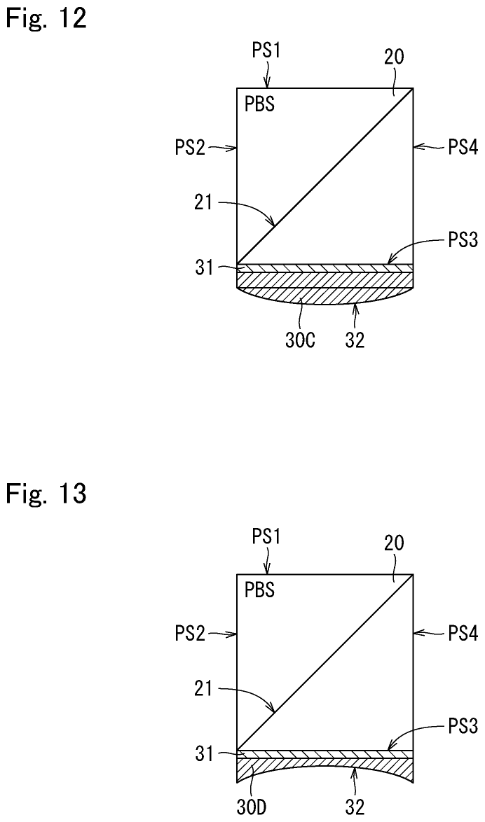

Alternatively, as illustrated in FIG. 9, the polarization beam splitter 20, the reflector element 30, and the retardation plate 31 may be disposed with a space therebetween.

Also such a configuration can produce the effect in the above-described embodiments. The deterioration of the retardation plate 31 may be further suppressed.

In the above-described embodiments, the example where the reflector element 30 has the flat reflecting surface 32 has been described. However, the reflecting surface 32 of reflector element 30 may be constituted by a curved surface.

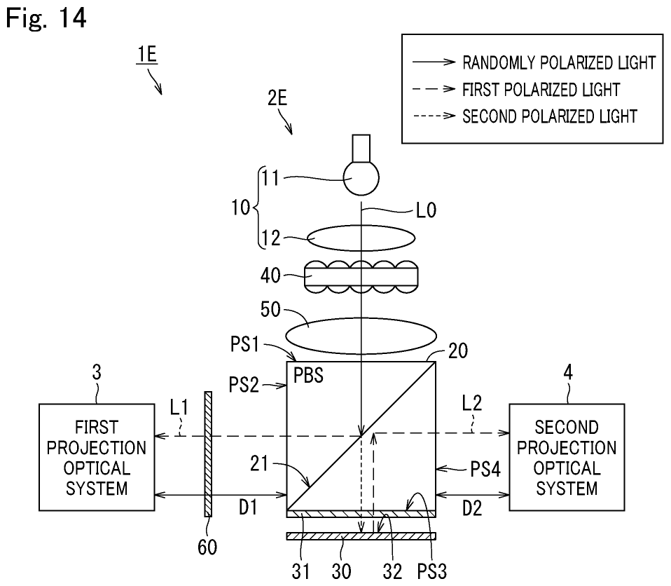

As illustrated in FIG. 10, a reflector element 30A may be, for example, a convex mirror. In this case, the reflecting surface 32 may be constituted by a convex curved surface.

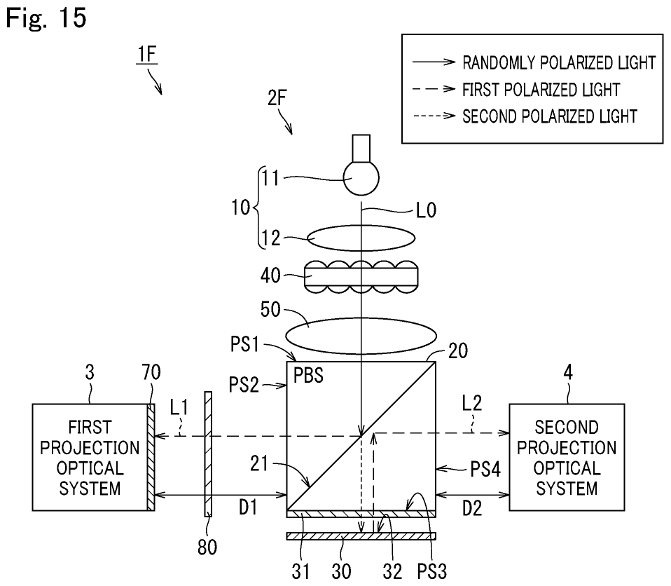

As illustrated in FIG. 11, a reflector element 30B may be, for example, a concave mirror. In this case, the reflecting surface 32 may be constituted by a concave curved surface.

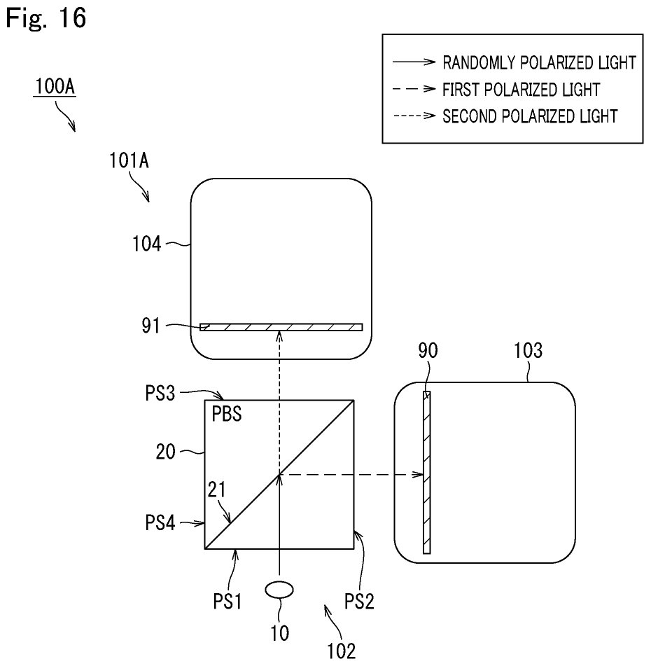

As illustrated in FIG. 12, a reflector element 30C may be, for example, a convex lens. In this case, the reflecting surface 32 may be constituted by a convex curved surface.

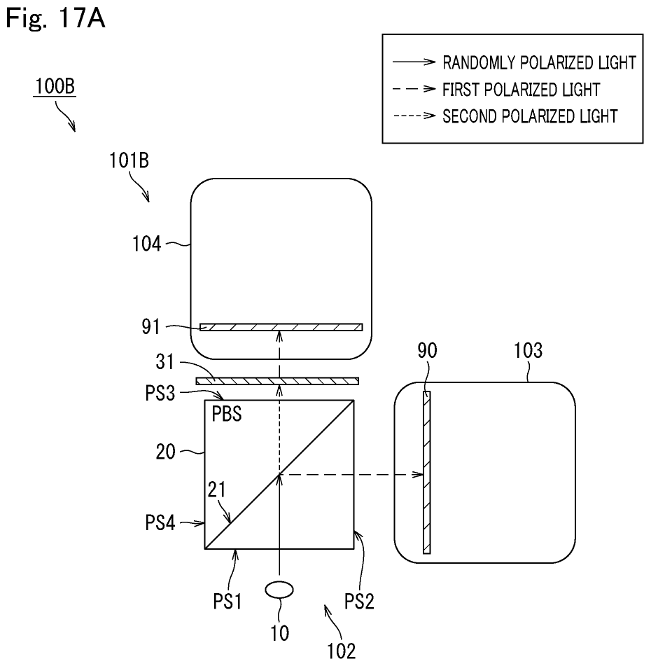

As illustrated in FIG. 13, a reflector element 30D may be, for example, a concave lens. In this case, the reflecting surface 32 may be constituted by a concave curved surface.

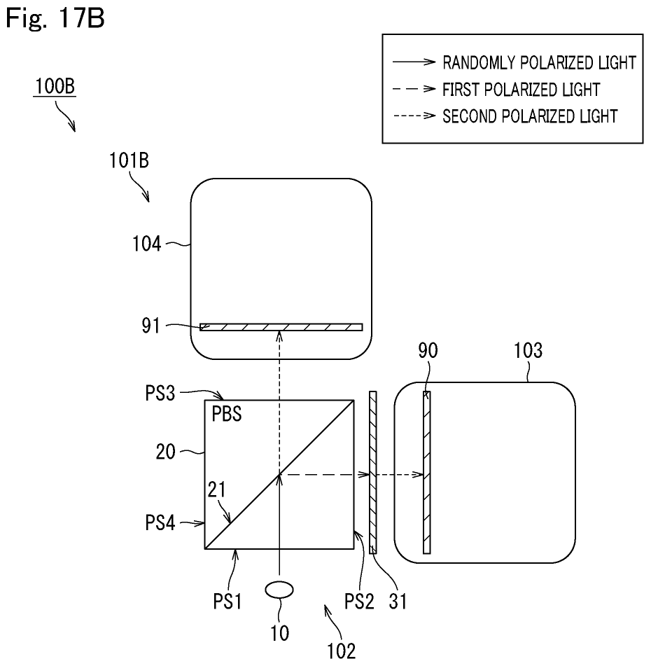

As illustrated in FIG. 14, in the illumination optical system 2E of optical system 1E, a ND filter 60 may be provided on the optical path of the first light L1 emitted from the second surface PS2 of the polarization beam splitter 20 until it enters the first projection optical system 3. The ND filter 60 is a filter for reducing the amount of light entering the first projection optical system 3. This configuration makes it possible to adjust the density of the ND filter 60 so that the amount of light entering the second projection optical system and the amount of light entering the first projection optical system are identical.

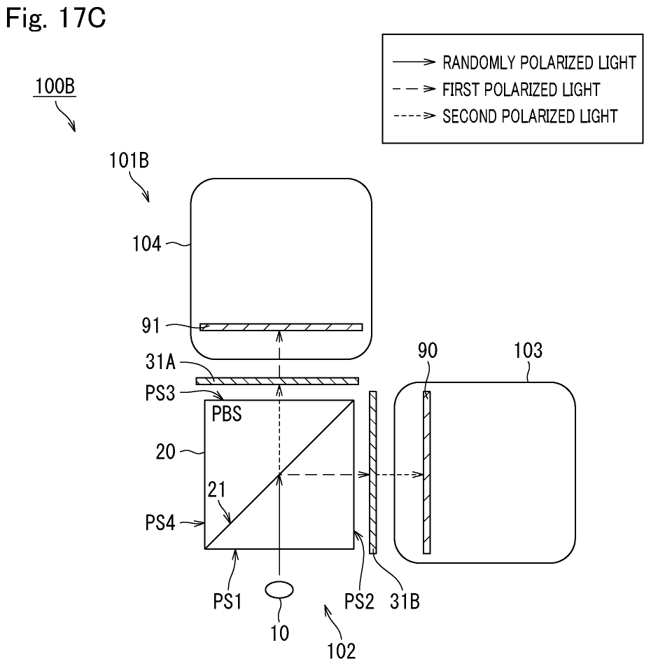

As illustrated in FIG. 15, in the illumination optical system 2F of optical system 1F, a polarizer 70 for transmitting a specific linearly polarized light and a retardation plate 80 for adjusting the amount of the light may be provided on the optical path of the first light L1 emitted from the second surface PS2 of the polarization beam splitter 20 until it enters the first projection optical system 3. The polarizer 70 should align the transmission axis of the polarizer 70 with the polarization direction of the first light L1. This configuration makes it possible to rotate a fast axis of the retardation plate 80 with respect to the polarization axis of the first light L1 and adjust the amount of light entering the first projection optical system.

In such a configuration, the effects of the embodiments described above can also be achieved. The second distance D2 can be adjusted by devising the shape of the reflecting surface 32. The luminance distribution of the second light L2 can be made uniform.

In the above embodiments, an example is described in which the lens element 50, the first lens element 51 and the second lens element 52 include a single lens, respectively. However, the lens element 50, the first lens element 51 and the second lens element 52 may include a plurality of lens elements, respectively. The lens element 50, the first lens element 51 and the second lens element 52 may be configured by a glass material or a resin material. The glass material improves reliability, while the resin material reduces costs.

### Sixth Embodiment

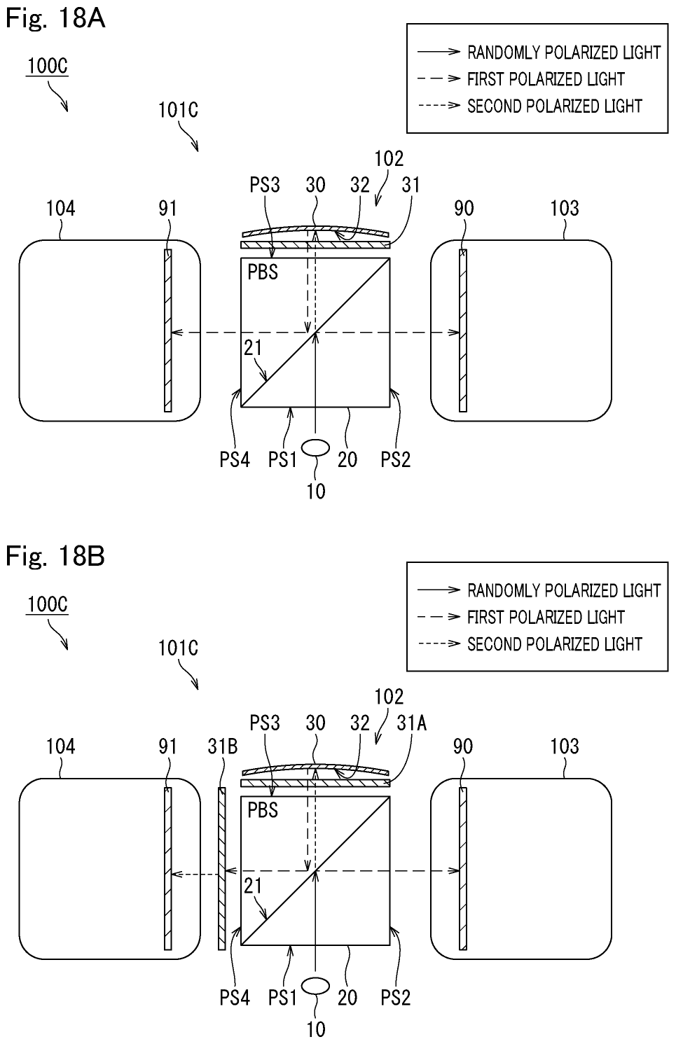

A display device 100A according to a sixth embodiment will be described with reference to FIG. 16. FIG. 16 is a schematic view for explaining a display device in the sixth embodiment.

The display device 100A according to the sixth embodiment includes an optical system 101A. The optical system 101A includes the illumination system 102, the first projection optical system 103 and the second projection system 104. The first projection optical system 103 and the second projection system 104 include the first display 90 and the second display 91. In the sixth embodiment, the configuration of the illumination system 102, the first projection optical system 103 and the second projection system 104 may adopt the configuration of the illumination systems 2 to 2F, the first projection system 3 and the second projection system 4 in the first to fifth embodiments and the other embodiment of optical systems, unless otherwise explained.

The illumination optical system 102 includes the light source 10 and the polarization beam splitter 20, and splits the random polarized light from the light source 10 into a first light in a first polarization state and a second light in a second polarization state by the split surface 21 of the polarization beam splitter 20. The illumination optical system 2 outputs the first light in the first direction and the second light in the second direction which is different from the first direction. The first direction is the direction that intersects the direction in which the random polarized light is output and the second direction is the same direction in which the random polarized light is output.

The present embodiment also describes an example where the light source light emitted from the light source 10 is randomly polarized. However, the light source light may be other light source light. For example, it may be linearly polarized light containing components of first and second polarization, light in which first and second polarization are combined, circularly polarized light, elliptically polarized light, or light in which these lights are combined. In other words, the light source light may be any light containing first and second polarization.

The light source 10 is arranged on the first surface PS1 side of the polarization beam splitter 20. The first projection optical system 103 is arranged on the second surface PS2 side. The second projection optical system 104 is arranged on the third surface PS3 side. The first surface PS1 of the polarization beam splitter 20 is an incident surface on which the random polarized light L0 from the light source 10 enters. The second surface PS2 is an exit surface on which the first light L1 is emitted. The third surface PS3 is an emitting surface from which the second light L2 is emitted.

The illumination optics 102 guides the first light to the first display 90 and the second light to the second display 91. For example, the first display 90 and the second display 91 can be liquid crystal displays or digital micromirror devices.

The first projection optical system 103 projects an image displayed on the first display 90 with the first light. The second projection optical system 104 projects an image displayed on the second display 91 with the second light.

Thus, the display device 100A of the sixth embodiment includes: the first projection optical system 103 having the first display 90 displaying the image; the second projection optical system 104 having the second display 91 displaying the image; and the illumination optical system 102 guiding light to the first projection optical system 103 and the second projection optical system 104. The illumination optical system 102 includes the light source 10 that collimates and emits light source light including the first and second polarized light, and a polarization beam splitter 20 including a split surface 21 that splits the light source light into the first light in the first polarization state and the second light in the second polarization state of the light source light. The illumination optical system 102 guides the first light to the first display 90 and the second light to the second display 91. The first projection optical system 103 projects the image displayed on the first display 90 with the first light. The second projection optical system 104 projects the image displayed on the second display 91 with the second light.

This configuration enables a compact size to be achieved while improving the light utilization efficiency of the light source 10. Specifically, a compact display device 100A can be realized because it can be illuminated by one illumination optical system 102 for two projection optical systems 103, 104.

### Seventh Embodiment

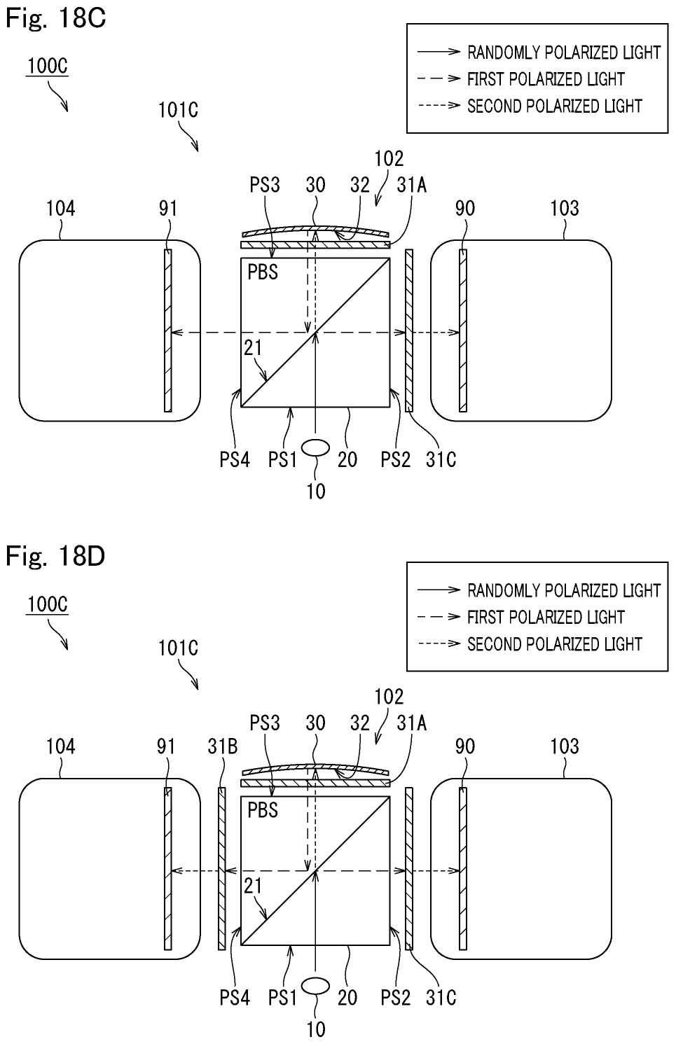

A display device 100B according to a seventh embodiment will be described with reference to FIG. 17. FIG. 17 is a schematic view for explaining a display device in the seventh embodiment.

In the display device 100B according to the seventh embodiment, the optical system 101B includes at least one retardation plate 31. The points of the configuration other than the above-described points and points described below are common between the display device 100B according to the seventh embodiment and the display device 100A according to the sixth embodiment.

The retardation plate 31 is located in the optical path of the split surface 21 of the polarization beam splitter 20 and the second projection optical system 104. The retardation plate 31 changes the second light split at the split surface 21 from the second polarization state to the first polarization state.

The retardation plate 31 changes the second light from the second polarization state to the first polarization state by providing retardation of λ/2 to the second light. For example, when configured with one retardation plate 31, the retardation plate 31 may be a ½ wave plate; when configured with two retardation plates 31, the two retardation plates 31 may be a ¼ wave plate, respectively.

The first projection optical system 103 and the second projection optical system 104 are configured to guide light in the polarization state of the incident light.

As described above, the display device 100B according to the seventh embodiment includes at least one retardation plates 31 on the optical path of the split surface 21 and the second projection optical system 104. At the at least one retardation plate 31, the second polarization state of the two lights split at the split surface 21 is changed to the first polarization state.

With such a configuration, the second light guided to the second projection optical system 104 can be brought into the same polarization state as the state of the first light guided to the first projection optical system 103 by the at least one retardation plate 31. Consequently, components can be shared between the first projection optical system 103 and the second projection optical system 104.

In the case of the projection optical system that guides the light in the first polarization state or the second polarization state, this system has the configuration where the first light and the second light split respectively in the first polarization state and the second polarization state from the illumination optical system 102. The configuration can reduce the loss of light in the first and second projection optical systems 103 and 104. Thus, the display device 100B efficiently using light can be configured.

FIG. 17B is a schematic view for explaining another example of the display device 100B according to the seventh embodiment.

As illustrated in FIG. 17B, the retardation plate 31 may be disposed on an optical path between the split surface 21 and the first projection optical system 103. In this case, at the retardation plate 31, the first polarization state of the first light split at the split surface 21 is changed to the second polarization state.

With such a configuration, the at least one retardation plates 31 enables the first light guided to the first projection optical system 103 to be brought into the same polarization state as the state of the second light guided to the second projection optical system 104. Consequently, components can be shared between the first projection optical system 103 and the second projection optical system 104.

FIG. 17C is a schematic view for explaining another example of the display device 100B according to the seventh embodiment.

As illustrated in FIG. 17C, at least one first retardation plate 31A may be disposed on the optical path of the split surface 21 and the second projection optical system 104, and at least one second retardation plate 31B may be disposed on the optical path of the split surface 21 and the first projection optical system 103.

With such a configuration, the first retardation plate 31A enables the second polarization state of the second light is changed to the first polarization state, and the second retardation plate 31B enables the first polarization state of the first light is changed to the second polarization state.

For example, in the display device 100B, in a case where the first projection optical system 103 is configured to receive and project the light in the second polarization state, the state of the first light guided to first projection optical system 103 can be changed to the second polarization state by the second retardation plate 31B. In a case where the second projection optical system 104 is configured to receive and project the light in the first polarization state, the state of the second light guided to the second projection optical system 104 can be changed to the first polarization state by the first retardation plate 31A. That is, the polarization states of the first light and the second light can be changed in accordance with the configurations of the first and second projection optical systems 103 and 104.

### Eighth Embodiment

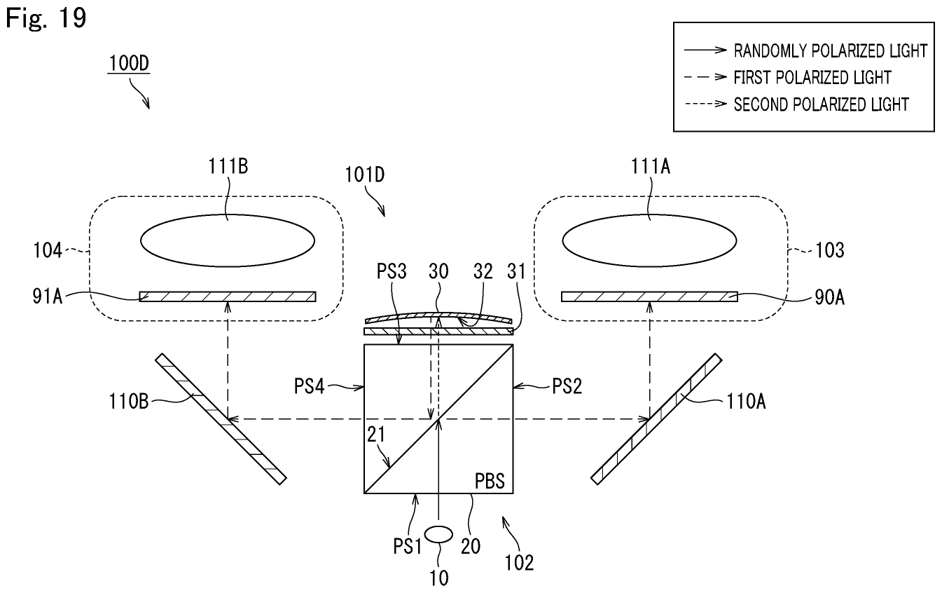

A display device 100C according to an eighth embodiment will be described with reference to FIG. 18A. FIG. 18A is a schematic view for explaining the display device 100C according to the eighth embodiment.

In the display device 100C according to the eighth embodiment, an optical system 101C includes a reflector element 30 and a retardation plate 31. The reflector element 30 and the retardation plate 31 are disposed on a third surface PS3 side of a polarization beam splitter 20. A second projection optical system 104 is disposed on a fourth surface PS4 side. The points of the configuration other than the above-described points and points described below are common between the display device 100C according to the eighth embodiment and the display device 100B according to the seventh embodiment.

The reflector element 30 is disposed on an opposite side of the retardation plate 31 from a split surface 21, and includes a reflecting surface 32 where the second light split from split surface 21 is reflected. In the present embodiment, the reflecting surface 32 is constituted by a curved surface.

At the retardation plate 31, the second polarization state of the second light L2 is changed to the first polarization state. The second light L2 passes through the retardation plate 31 to enter the reflecting surface 32 from the split surface 21, and is reflected from the reflecting surface 32. The second light L2 reflected from the reflecting surface 32 passes through the retardation plate 31 to enter the split surface 21. In such a way, the second light L2 passes through the retardation plate 31 twice to have retardation of λ/2. As a result, the second polarization state of the second light L2 is changed to the first polarization state.

For example, in a case of including one retardation plate 31, the retardation plate 31 is a ¼ wave plate. In a case of including the two retardation plates 31, each of the two retardation plates 31 is a ⅛ wave plate.

The second light changed to the first polarization state via the reflector element 30 and the retardation plate 31 is reflected from the split surface 21 of the polarization beam splitter 20. The second light is then emitted from a fourth surface PS3 and guided to a second display 91 of the second projection optical system 104.

Also such a configuration where the first light and the second light split into the first polarization state and the second polarization state are guided from an illumination optical system 102 can reduce the loss of light in the first and second projection optical systems 103 and 104. Thus, the display device 100B efficiently using light can be configured.

FIG. 18B is a schematic view for explaining another example of the display device 100C according to the eighth embodiment.

As illustrated in FIG. 18B, the display device 100C may include at least one first retardation plate 31A and at least one second retardation plate 31B on an optical path between the split surface 21 and the second projection optical system 104. The first retardation plate 31A is disposed on the third surface PS3 side of the polarization beam splitter 20. The second retardation plate 31B is disposed on the fourth surface PS4 side.

At the first retardation plate 31A and the second retardation plate 31B, the second polarization state is changed to the first polarization state by giving retardation of λ/2 to the second light. For example, in a case of including the one first retardation plate 31A, the first retardation plate 31A is a ¼ wave plate. In a case of including the two first retardation plates 31A, each of the two first retardation plates 31A is a ⅛ wave plate. For example, in a case of including the one second retardation plate 31B, the second retardation plate 31B is a ½ wave plate. In a case of including the two second retardation plates 31B, each of the two second retardation plates 31B is a ¼ wave plate.

The second light in the first polarization state emitted from the fourth surface PS4 of the polarization beam splitter 20 may be changed to the second polarization state by the second retardation plate 31B, and guided to the second display 91 of the second projection optical system 104. The second projection optical system 104 may guide the incident second light in the second polarization state.

FIG. 18C is a schematic view for explaining another example of the display device 100C according to the eighth embodiment.

As illustrated in FIG. 18C, the display device 100C may include at least one first retardation plate 31A on the optical path between the split surface 21 and the second projection optical system 104, and at least one third retardation plate 31C on the optical path between the split surface 21 and the first projection optical system 103. The first retardation plate 31A is disposed on the second surface PS2 side of the polarization beam splitter 20. The third retardation plate 31C is disposed on the second surface PS2 side.

At the third retardation plate 31C, the first polarization state of the first light is changed to the second polarization state by giving retardation of λ/2 to the first light. For example, in a case of including one third retardation plate 31C, the third retardation plate 31C is a ½ wave plate. In a case of including the two third retardation plates 31C, each of the two third retardation plates 31C is a ¼ wave plate.

The first light in the first polarization state emitted from the second surface PS2 of the polarization beam splitter 20 may be brought into the second polarization state by the third retardation plate 31C, and guided to the first display 90 of the first projection optical system 103. The first projection optical system 103 may guide the incident first light in the second polarization state.

FIG. 18D is a schematic view for explaining another example of the display device 100C according to the eighth embodiment.

As illustrated in FIG. 18D, the display device 100C may include at least one first retardation plate 31A and at least one second retardation plate 31B, and at least one third retardation plate 31C.

Also such a configuration where the first light and the second light split into the first polarization state and the second polarization state are guided from an illumination optical system 102 can reduce the loss of light in the first and second projection optical systems 103 and 104. Thus, the display device 100C efficiently using light can be configured.

### Ninth Embodiment

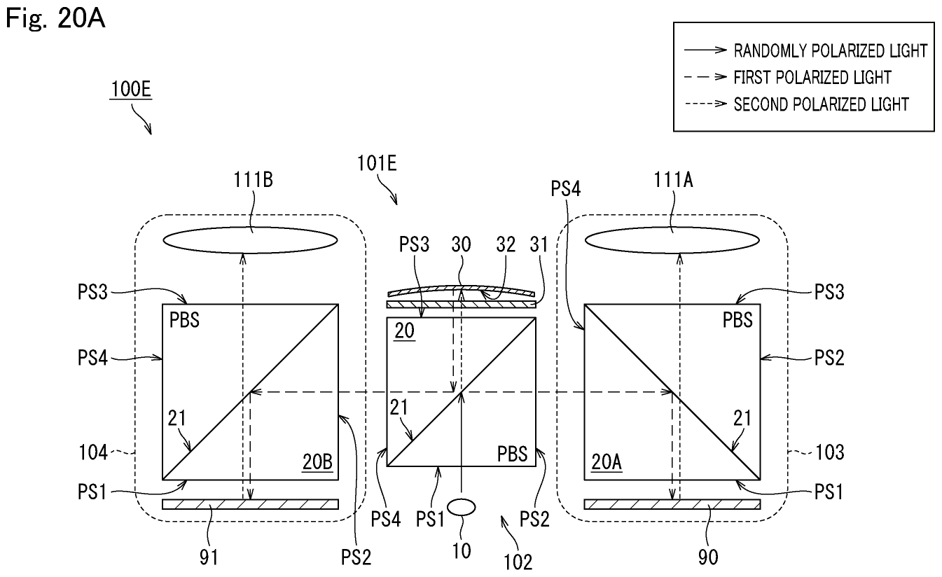

A display device 100D according to a ninth embodiment will be described with reference to FIG. 19. FIG. 19 is a schematic view for explaining the display device 100D according to the ninth embodiment.

In an optical system 101D of the display device 100D according to the ninth embodiment, a first display 90A in a first projection optical system 103 and a second display 91A in a second projection optical system 104 are liquid crystal displays. The points of the configuration other than the above-described points and points described below are common between the display device 100D according to the ninth embodiment and the display device 100C according to the eighth embodiment.

In the display device 100D, first light in the first polarization state split at a split surface 21 is emitted from a second surface PS2 of a polarization beam splitter 20, reflected by a mirror 110A, and enters the first display 90A of the first projection optical system 103.

Second light in the second polarization state split at the split surface 21 is emitted from a third surface PS3 of the polarization beam splitter 20, and passes through a reflector element 30 and a retardation plate 31. The second light is then brought into the first polarization state, reflected from the split surface 21, and is emitted from a fourth surface PS4. The second light emitted from the fourth surface PS4 is reflected by a mirror 110B and enters the second display 91A of the second projection optical system 104.

The first display 90A and the second display 91A are liquid crystal displays that guide light in a polarization state of incident light. The liquid crystal displays may be either transmissive type or reflective type displays.

Specifically, the first display 90A guides the first light in the first polarization state. The second display 91A guides the second light in the first polarization state. For example, the images to be displayed on the first display 90A and the second display 91A are projected through lens elements 111A and 111B, respectively.

As described above, in the display device 100D according to the eighth embodiment, the first display 90A and the second display 91A are liquid crystal displays that guide light in a polarization state of incident light.

With such a configuration, the first projection optical system 103 and the second projection optical system 104 can be configured at low cost.

In the present embodiment, the example where the display device 100D includes the mirrors 110A and 110B has been described. However, the mirrors 110A and 110B are not essential components.

In the present embodiment, the example where the first display 90A and the second display 91A guide light in the first polarization state has been described. However, the first display 90A and the second display 91A may guide the light in the second polarization state.

### Tenth Embodiment

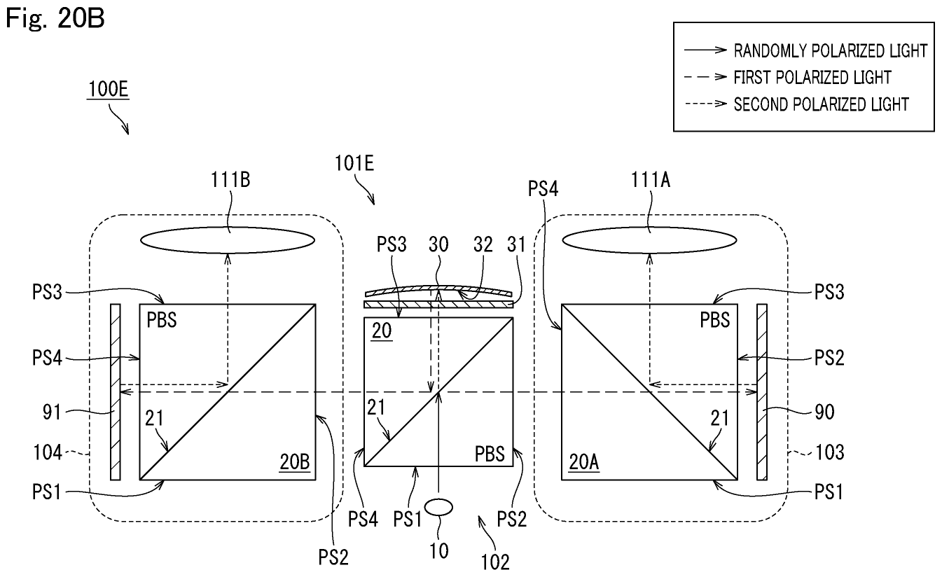

With reference to FIG. 20A, a display device 100E according to a tenth embodiment will be described. FIG. 20A is a schematic view for explaining the display device 100E according to the tenth embodiment.

In an optical system 101E of the display device 100E according to the tenth embodiment, a first projection optical system 103 and a second projection optical system 104 respectively include polarization beam splitters 20A and 20B. The points of the configuration other than the above-described points and points described below are common between the display device 100E according to the tenth embodiment and the display device 100C according to the eighth embodiment.

The first projection optical system 103 includes a first polarization beam splitter 20A, a first display 90, and a first lens 111A.

The first polarization beam splitter 20A includes first to fourth surfaces PS1 to PS4. The first display 90 is disposed on a first surface PS1 side of the first polarization beam splitter 20A. The first display 90 and the first lens 111A are disposed on a third surface PS3 side of the first polarization beam splitter 20A.

First light in the first polarization state emitted from the second surface PS2 of the polarization beam splitter 20 of an illumination optical system 102 enters the first projection optical system 103. The first light enters the fourth surface PS4 of the first polarization beam splitter 20A, is reflected from the split surface 21, and is emitted from the first surface PS1. The first light emitted from the first surface PS1 enters the first display 90. The first display 90 converts the first light in the first polarization state into image light in the second polarization state and reflects the image light. The image light converted by the first display 90 enters the first surface PS1 of the first polarization beam splitter 20A, is transmitted through the split surface 21, and is emitted from the third surface PS3. The image light emitted from the third surface PS3 is projected through the first lens 111A.

The second projection optical system 104 includes a second polarization beam splitter 20B, a second display 91, and a second lens 111B.

The second polarization beam splitter 20B includes first to fourth surfaces PS1 to PS4. The second display 91 is disposed on a first surface PS1 side of the second polarization beam splitter 20B. The second display 91 and the second lens 111B are disposed on a third surface PS3 side of the second polarization beam splitter 20B.

Second light in the first polarization state emitted from the fourth surface PS4 of the polarization beam splitter 20 of the illumination optical system 102 enters the second projection optical system 104. The second light enters the second surface PS2 of the second polarization beam splitter 20B, is reflected from the split surface 21, and is emitted from the first surface PS1. The second light emitted from the first surface PS1 enters the second display 91. The second display 91 converts the second light in the first polarization state into image light in the second polarization state and reflects the image light. The image light converted by the second display 91 enters the first surface PS1 of the second polarization beam splitter 20B, is transmitted through the split surface 21, and is emitted from the third surface PS3. The image light emitted from the third surface PS3 is projected through the second lens 111B.

As described above, in the display device 100E according to the tenth embodiment, the first projection optical system 103 and the second projection optical system 104 respectively include the first polarization beam splitter 20A and the second polarization beam splitter 20B that guide light in a polarization state of incident light.

With such a configuration, the optical path lengths of the first projection optical system 103 and the second projection optical system 104 can be adjusted while an increase in size of the first projection optical system 103 and the second projection optical system 104 is being suppressed. Further, the light entering the first display 90 and the light emitted from the first display 90 can be used separately with the entering light and emitted light being coaxial. In a similar way, the light entering the second display 91 and the light emitted from the second display 91 can be used separately with the entering light and emitted light being coaxial.

FIG. 20B is a schematic view for explaining another example of the display device 100E according to the tenth embodiment.

As illustrated in FIG. 20B, the split surfaces 21 of the first polarization beam splitter 20A and the second polarization beam splitter 20B may allow the light in the first polarization state to be transmitted and the light in the second polarization state to be reflected. In this case, the first display 90 may be disposed on the second surface PS2 of the first polarization beam splitter 20A. The second display 91 may be disposed on the fourth surface PS4 side of the second polarization beam splitter 20B.

In the first projection optical system 103, the first light in the first polarization state emitted from the illumination optical system 102 enters the fourth surface PS4 of the first polarization beam splitter 20A, is transmitted through the split surface 21, and is emitted from the second surface PS2. The first light emitted from the second surface PS2 enters the first display 90. The first display 90 converts the first light in the first polarization state into image light in the second polarization state and reflects the image light. The image light converted by the first display 90 enters the second surface PS2 of the first polarization beam splitter 20A, is reflected from the split surface 21, and is emitted from the third surface PS3.

In the second projection optical system 104, the second light in the first polarization state emitted from the illumination optical system 102 enters the third surface PS3 of the second polarization beam splitter 20B, is transmitted through the split surface 21, and is emitted from the fourth surface PS4. The second light emitted from the fourth surface PS4 enters the second display 91. The second display 91 converts the second light in the first polarization state into image light in the second polarization state and reflects the image light. The image light converted by the second display 91 enters the fourth surface PS4 of the second polarization beam splitter 20B, is reflected from the split surface 21, and is emitted from the third surface PS3.

With such a configuration, the optical path lengths of the first projection optical system 103 and the second projection optical system 104 can be adjusted while an increase in size of the first projection optical system 103 and the second projection optical system 104 is being suppressed. Further, the light entering the first display 90 and the light emitted from the first display 90 can be used separately with the entering light and emitted light being coaxial. In a similar way, the light entering the second display 91 and the light emitted from the second display 91 can be used separately with the entering light and emitted light being coaxial.

In the present embodiment, the first display 90 and the second display 91 are achieved by, for example, reflective liquid crystal displays. Alternatively, the first display 90 and the second display 91 may be achieved by digital micromirror devices and wave plates.

The above embodiments have been described as the examples of the technique disclosed in this application. However, the technique in the present disclosure is not limited to them, and is applicable to embodiments where changes, replacements, additions, omissions, combinations, etc. are made as appropriate.

In this specification, the terms “first”, “second”, and the like are only used for description, and should not be understood as explicitly or implying of relative importance or a rank of technical features. The features limited to “first” and “second” are intended to clarify or imply the inclusion of one or more such features.

### Outline of Embodiments

(1) A display device of the present disclosure includes a first projection optical system including a first display that displays an image, a second projection optical system including a second display that displays an image, and an illumination optical system that guides light to the first projection optical system and the second projection optical system. The illumination optical system includes a light source that collimates light source light including first polarized light and second polarized light and emits the collimated light, and a polarization beam splitter including a split surface where the light source light is split into first light in a first polarization state and second light in a second polarization state. The illumination optical system guides the first light to the first display and guides the second light to the second display. The first projection optical system projects the image displayed on the first display with the first light, and the second projection optical system projects the image displayed on the second display with the second light.

(2) The display device of (1) further includes at least one retardation plate on an optical path of the split surface and the second projection optical system, the at least one retardation plate being configured to bring the second light in the second polarization state split at the split surface into the first polarization state.

(3) In the display device of (2), the illumination optical system includes a reflector element on an opposite side of the at least one retardation plate from the split surface, the reflector element including a reflecting surface where the second light split from the split surface is reflected, the at least one retardation plate allows the second light in the second polarization state to be brought into the first polarization state, and at the split surface, the second light brought into the first polarization state is reflected and is guided to the second display.

(4) In the display device of (1) or (3), the first projection optical system and the second projection optical system each may guide incident light in the first polarization state or the second polarization state.

(5) In the display device of (4), the first display and the second display each may be liquid crystal displays that guide incident light in a polarization state of incident light.

(6) In the display device of (4) or (5), the first projection optical system and the second projection optical system each further include a polarization beam splitter that guides light in a polarization state of incident light.

(7) The display device of any one of (1) to (6), may further include a first light guide device that guides light projected from the first projection optical system to a first region where a first eye of a user is located, and a second light guide device that guides light projected from the second projection optical system to a second region where a second eye of the user is located. The first light guide device and the second light guide device guide light in a polarization state of incident light.

(8) In the display device of (3), the first projection optical system is disposed away from an emission surface of the polarization beam splitter for the first light by a first distance, the second projection optical system is disposed away from an emission surface of the polarization beam splitter for the second light by a second distance, and wherein the second distance is shorter than the first distance.

(9) In the display device of (3), the illumination optical system may further include a first lens element disposed on an optical path of the first light emitted from the polarization beam splitter, the first lens element being configured to condense the first light, and a second lens element disposed on an optical path of the second light emitted from the polarization beam splitter, the second lens element being configured to condense the second light, and the first lens element has a refractive power greater than a refractive power of the second lens element.

(10) The display device of any one of (1) to (9), further includes a lens array element that allows light emitted from the light source to be split into a plurality of secondary light source lights, and a lens element that allows the plurality of secondary light source lights from the lens array element is condensed.

(11) In the display device of (10), the lens array element may be disposed between the light source and the polarization beam splitter.

(12) In the display device of (10) or (11), the lens element includes a first lens element disposed on an optical path of the first light emitted from the polarization beam splitter, the first lens element being configured to condense the first light, and a second lens element disposed on an optical path of the second light emitted from the polarization beam splitter, the second lens element being configured to condense the second light.

(13) In the display device of (12), the lens array element may include a first lens array element disposed between the polarization beam splitter and the first lens element, and a second lens array element disposed between the polarization beam splitter and the second lens element.

(14) In the display device of (3), the reflecting surface may include a curved surface.

(15) In the display device of any one of (1) to (14), the light source may include a light source element that that allows the light source light is generated, and a collimator element that allows the light source light generated by the light source element is collimated.

(16) The display device of any one of (1) to (15), may be a head mount display in which the first projection optical system projects an image for a right eye of a user, and the second projection optical system projects an image for a left eye of the user.

(17) An optical system of the present disclosure that guides light to a first display of a first projection optical system and a second display of a second projection optical system includes a light source that collimates light source light including first polarized light and second polarized light and emits the collimated light, and a polarization beam splitter including a split surface where the light source light is split into first light in a first polarization state and second light in a second polarization state. The first light is guided to the first display, and the second light is guided to the second display.

The present disclosure is applicable to, for example, an optical system, such as a head mount display, of a projection image display device that projects two images.

What is claimed is:

1. A display device comprising:
a first projection optical system including a first display that displays an image;
a second projection optical system including a second display that displays an image; and
an illumination optical system that guides light to the first projection optical system and the second projection optical system,
wherein the illumination optical system includes
a light source that collimates light source light including first polarized light and second polarized light and emits the collimated light, and
a polarization beam splitter including a split surface where the light source light is split into first light in a first polarization state and second light in a second polarization state,
wherein the illumination optical system guides the first light to the first display and guides the second light to the second display, and
wherein the first projection optical system projects the image displayed on the first display with the first light, and the second projection optical system projects the image displayed on the second display with the second light.

2. The display device according to claim 1, further comprising at least one retardation plate on an optical path of the split surface and the second projection optical system, the at least one retardation plate allowing the second light in the second polarization state split at the split surface to be brought into the first polarization state.

3. The display device according to claim 2, wherein the illumination optical system includes a reflector element on an opposite side of the at least one retardation plate from the split surface, the reflector element including a reflecting surface where the second light split from the split surface is reflected,
wherein the at least one retardation plate allows the second light in the second polarization state to be brought into the first polarization state, and
wherein at the split surface, the second light brought into the first polarization state is reflected and is guided to the second display.

4. The display device according to claim 1, wherein the first projection optical system and the second projection optical system guide incident light in the first polarization state or the second polarization state.

5. The display device according to claim 4, wherein the first display and the second display are liquid crystal displays that guide light in a polarization state of incident light.

6. The display device according to claim 4, wherein the first projection optical system and the second projection optical system each further include a polarization beam splitter that guides light in a polarization state of incident light.

7. The display device according to claim 1, further comprising:
a first light guide device that guides light projected from the first projection optical system to a first region where a first eye of a user is located; and
a second light guide device that guides light projected from the second projection optical system to a second region where a second eye of the user is located,
wherein the first light guide device and the second light guide device guide light in a polarization state of incident light.

8. The display device according to claim 3,
wherein the first projection optical system is disposed away from an emission surface of the polarization beam splitter for the first light by a first distance,
wherein the second projection optical system is disposed away from an emission surface of the polarization beam splitter for the second light by a second distance, and
wherein the second distance is shorter than the first distance.

9. The display device according to claim 3, wherein the illumination optical system further includes
a first lens element disposed on an optical path of the first light emitted from the polarization beam splitter, the first lens element being configured to condense the first light, and
a second lens element disposed on an optical path of the second light emitted from the polarization beam splitter, the second lens element being configured to condense the second light, and
wherein the first lens element has a refractive power greater than a refractive power of the second lens element.

10. The display device according to claim 1, further comprising:
a lens array element configured to split light emitted from the light source into a plurality of secondary light source lights; and
a lens element configured to condense the plurality of secondary light source lights from the lens array element.

11. The display device according to claim 10, wherein the lens array element is disposed between the light source and the polarization beam splitter.

12. The display device according to claim 10,
wherein the lens element includes
a first lens element disposed on an optical path of the first light emitted from the polarization beam splitter, the first lens element being configured to condense the first light, and
a second lens element disposed on an optical path of the second light emitted from the polarization beam splitter, the second lens element being configured to condense the second light.

13. The display device according to claim 12, wherein the lens array element includes
a first lens array element disposed between the polarization beam splitter and the first lens element, and
a second lens array element disposed between the polarization beam splitter and the second lens element.

14. The display device according to claim 3, wherein
the reflecting surface includes a curved surface.

15. The display device according to claim 1, wherein the light source includes
a light source element being configured to generate the light source light; and
a collimator element being configured to collimate the light source light generated by the light source element.

16. The display device according to claim 1, being a head mount display in which the first projection optical system projects an image for a first eye of a user, and the second projection optical system projects an image for a second eye of the user.

17. An optical system that guides light to a first display of a first projection optical system and a second display of a second projection optical system, the optical system comprising:
a light source that collimates light source light including first polarized light and second polarized light and emits the collimated light; and
a polarization beam splitter including a split surface where the light source light is split into first light in a first polarization state and second light in a second polarization state;
wherein the first light is guided to the first display, and the second light is guided to the second display.
